(19) United States
(12) Patent Application Publication
(10) Pub. No.: US 2021/0398316 A1
(43) Pub. Date: Dec. 23, 2021

(54) SYSTEMATIC POSITIONING OF VIRTUAL OBJECTS FOR MIXED REALITY

(71) Applicant: KONINKLIJKE PHILIPS N.V., EINDHOVEN (NL)

(72) Inventors: Ashish PANSE, BURLINGTON, MA (US); Molly FLEXMAN, MELROSE, MA (US)

(21) Appl. No.: 17/292,732

(22) PCT Filed: Nov. 8, 2019
(86) PCT No.: PCT/EP2019/080629

§ 371 Date: May 11, 2021

Related U.S. Application Data
(60) Provisional application No. 62/767,634, filed on Nov. 15, 2018.

(51) Int. Cl. G06T 7/73; G06T 19/00

(52) U.S. Cl. CPC G06T 7/73; G06T 2207/30204; G06T 19/006

(57) ABSTRACT

An augmented reality device (50) employing an augmented reality display (53) for displaying a virtual object relative to a view of a physical object within a physical world. The device (50) further employs a virtual object positioning controller (60) for autonomously controlling a positioning of the virtual object within the augmented reality display (53) based on a decisive aggregation implementation of spatial positioning rule(s) regulating the positioning of the virtual object within the augmented reality display (53) and a sensing of the physical world (e.g., an object detection of physical object(s) within the physical world, a pose detection of the augmented reality display (53) relative to the physical world, and/or an ambient detection of an operating environment of the augmented reality display (53) relative to the physical world). The decisive aggregation may further include an operational assessment and/or virtual assessment of the augmented reality display (53).

### FIELD OF THE INVENTION

The present disclosure generally relates to an utilization of augmented reality, particularly in a medical setting. The present disclosure specifically relates to a systematic positioning of a virtual object within an augmented reality display relative to a view within the augmented reality display of a physical object in a physical world.

### BACKGROUND OF THE INVENTION

Augmented reality generally refers to when a live image stream of a physical world is supplemented with additional computer-generated information. Specifically, the live image stream of the physical world may be visualized/displayed via glasses, cameras, smart phones, tablets, etc., and the live image stream of the physical world is augmented via a display to the user that can be done via glasses, contact lenses, projections or on the live image stream device itself (smart phone, tablet, etc.). Examples of an implementation of wearable augmented reality device or apparatus that overlays virtual objects on the physical world include, but are not limited to, GOOGLE GLASS™, HOLOLENS™, MAGIC LEAP™, VUSIX™ and META™.

More particularly, mixed reality is a type of augmented reality that merges a virtual world of content and items into the live image/image stream of the physical world. A key element to mixed reality includes a sensing of an environment of the physical world in three-dimensions (“3D”) so that virtual objects may be spatially registered and overlaid onto the live image stream of the physical world. Such augmented reality may provide key benefits in the area of image guided therapy and surgery including, but not limited to, virtual screens to improve workflow and ergonomics, holographic display of complex anatomy for improved understanding of 3D geometry, and virtual controls for more flexible system interaction.

However, while mixed reality displays can augment the live image stream of the physical world with virtual objects (e.g., computer screens and holograms) to thereby interleave physical object(s) and virtual object(s) in a way that may significantly improve the workflow and ergonomics in medical procedures, a key issue is a virtual object must co-exist with physical object(s) in the live image stream in a way that optimizes the positioning of the virtual object relative to the physical object(s) and appropriately prioritizes the virtual object. There are two aspects to that need to be addressed for this issue. First, a need of a decision process for positioning a virtual object relative to the physical object(s) within the live image stream based on the current conditions of the physical world. Second, a need of a reaction process to respond to a changing environment of the physical world.

Moreover, for mixed reality, spatial mapping is a process of identifying surfaces in the physical world and creating a 3D mesh of those surfaces. This is typically done through the use SLAM (Simultaneous Localization and Mapping) algorithms to construct and update a map of an unknown environment using a series of multiple grayscale camera views via a depth sensing cameras (e.g., Microsoft Kinect). The common reasons for spatial mapping of the environment is a placement of virtual objects in the appropriate context, an occlusion of objects involving a physical object that is in front of a virtual object blocking a visualization of the virtual object, and adherence to physics principles, such as, for example, a virtual object visualized as sitting on a table or on the floor versus hovering in the air.

Interventional rooms are becoming increasingly virtual whereby virtual objects visualized through head-mounted augmented reality devices will eventually dominate the traditionally physical workspace. As stated, in mixed reality, virtual objects are visualized within the context of the physical world, and in order to anchor those visual objects within a live image stream of the intervention room, spatial mapping has to be relied upon to accurately map the virtual world. Additionally, spatial mapping has to also be flexible enough to enable a virtual object to follow other physical object(s) as such physical object(s) move within the physical world.

However, while spatial mapping has proven to identifying surfaces in the physical world, there are several limitations or drawbacks to spatial mapping in an intervention room. First, there is significant movement of equipment within the intervention room resulting in a minimization or lack of anchoring points for virtual object(s) in the live image stream of intervention room. Second, most equipment in the intervention room, especially those that would be within a field-of-view of augmented reality devices, are draped for sterile purposes (e.g., a medical imaging equipment). This makes such physical objects sub-optimal for mapping algorithms, which often rely on edge features. Finally, most interventional procedures require high spatial mapping accuracy (e.g., <2 mm), which is difficult to obtain, especially in view of the minimization or lack of anchoring points for virtual object(s) in the live image stream of intervention room and the presence of draped equipment.

### SUMMARY OF THE INVENTION

It is an object of the invention to provide a controller for autonomous positioning of a virtual object relative to an augmented reality display view of a physical object within a physical world. The autonomous positioning may be automatically performed by the controller and/or may be presented by the controller as a recommendation, which is acceptable or declinable.

According to a first aspect of the invention, this object is realized by an augmented reality display for displaying a virtual object relative to a view of physical object(s) within a physical world, and a virtual object positioning controller for autonomously controlling a positioning of the virtual object within the augmented reality display based on a decisive aggregation of an implementation of spatial positioning rule(s) regulating the positioning of the virtual object within the augmented reality display, and sensing of the physical world (e.g., an object detection of the physical object within the physical(s) world, a pose detection of the augmented reality display relative to the physical world and/or an ambient detection of an operating environment of the augmented reality display relative to the physical world). In other words, the controlling a positioning of the virtual object within the augmented reality display based on received (or inputted) signal or signals indicative of (i) spatial positioning rule(s) regulating the positioning of the virtual object within the augmented reality display and (ii) a sensing of the physical world (e.g. information gathered by one or more sensors (removably) coupled to the augmented reality device which sensor(s) generate information indicative of the physical world).

The decisive aggregation by the controller may further include an operational assessment of technical specification(s) of the augmented reality display, and a virtual assessment of a positioning of one or more additional virtual object(s) within the augmented reality display.

According to another aspect of the invention, the object is realized by a non-transitory machine-readable storage medium encoded with instructions for execution by one or more processors. The non-transitory machine-readable storage medium comprising instructions to autonomously control a positioning of a virtual object within an augmented reality display displaying the virtual object relative to a view of physical object(s) within a physical world.

The autonomous control of the positioning of a virtual object within an augmented reality display is based on a decisive aggregation of an implementation of spatial positioning rule(s) regulating the positioning of the virtual object within the augmented reality display, and sensing of the physical world (e.g., an object detection of the physical object within the physical(s) world, a pose detection of the augmented reality display relative to the physical world and/or an ambient detection of an operating environment of the augmented reality display relative to the physical world). In other words, the autonomous control of the positioning of the virtual object within the augmented reality display is based on received (or inputted) signal or signals indicative of (i) spatial positioning rule(s) regulating the positioning of the virtual object within the augmented reality display and (ii) a sensing of the physical world (e.g. information gathered by one or more sensors (removably) coupled to the augmented reality device which sensor(s) generate information indicative of the physical world).

The decisive aggregation may further include an operational assessment of technical specification(s) of the augmented reality display, and a virtual assessment of a positioning of one or more additional virtual object(s) within the augmented reality display.

According to a further aspect of the invention, the object is realized by an augmented reality method involving an augmented reality display displaying a virtual object relative to a view of a physical object within a physical world.

The augment reality method further involves a virtual object positioning controller autonomously controlling a positioning of the virtual object within the augmented reality display based on a decisive aggregation of an implementation of spatial positioning rule(s) regulating the positioning of the virtual object within the augmented reality display, and sensing of the physical world (e.g., an object detection of the physical object within the physical(s) world, a pose detection of the augmented reality display relative to the physical world and/or an ambient detection of an operating environment of the augmented reality display relative to the physical world). In other words, the controlling of the positioning of the virtual object within the augmented reality display is based on received (or inputted) signal or signals indicative of (i) spatial positioning rule(s) regulating the positioning of the virtual object within the augmented reality display and (ii) a sensing of the physical world (e.g. information gathered by one or more sensors (removably) coupled to the augmented reality device which sensor(s) generate information indicative of the physical world

The decisive aggregation by the controller may further include an operational assessment of technical specification(s) of the augmented reality display, and a virtual assessment of a positioning of one or more additional virtual object(s) within the augmented reality display.

For purposes of describing and claiming the present disclosure:

(1) terms of the art including, but not limited to, “virtual object”, “virtual screen”, “virtual content”, “virtual item”, “physical object”, “physical screen”, “physical content”, “physical item”, “physical world”, “spatial mapping” and “object recognition” are to be interpreted as known in the art of the present disclosure and as exemplary described in the present disclosure;

(2) the term “augmented reality device” broadly encompasses all devices, as known in the art of the present disclosure and hereinafter conceived, implementing an augmented reality overlaying virtual object(s) on a view of a physical world. Examples of an augmented reality device include, but are not limited to, augmented reality head-mounted displays (e.g., GOOGLE GLASS™, HOLOLENS™, MAGIC LEAP™, VUSIX™ and META™);

(3) the term “enhanced augmented reality device” broadly encompasses any and all augmented reality devices implementing the inventive principles of the present disclosure directed to a positioning of a virtual object relative to an augmented reality display view of a physical object within a physical world as exemplary described in the present disclosure;

(4) the term “decisive aggregation” broadly encompasses a systematic determination of an outcome from an input of a variety of information and data;

(5) the term “controller” broadly encompasses all structural configurations, as understood in the art of the present disclosure and as exemplary described in the present disclosure, of main circuit board or integrated circuit for controlling an application of various inventive principles of the present disclosure as exemplary described in the present disclosure. The structural configuration of the controller may include, but is not limited to, processor(s), computer-usable/computer readable storage medium(s), an operating system, application module(s), peripheral device controller(s), slot(s) and port(s). A controller may be housed within or communicatively linked to an enhanced augmented reality device;

(6) the term “application module” broadly encompasses an application incorporated within or accessible by a controller consisting of an electronic circuit (e.g., electronic components and/or hardware) and/or an executable program (e.g., executable software stored on non-transitory computer readable medium(s) and/or firmware) for executing a specific application; and

(7) the terms “signal”, “data” and “command” broadly encompasses all forms of a detectable physical quantity or impulse (e.g., voltage, current, or magnetic field strength) as understood in the art of the present disclosure and as exemplary described in the present disclosure for transmitting information and/or instructions in support of applying various inventive principles of the present disclosure as subsequently described in the present disclosure. Signal/data/command communication various components of the present disclosure may involve any communication method as known in the art of the present disclosure including, but not limited to, signal/data/command transmission/reception over any type of wired or wireless datalink and a reading of signal/data/commands uploaded to a computer-usable/computer readable storage medium.

The foregoing embodiments and other embodiments of the present disclosure as well as various structures and advantages of the present disclosure will become further apparent from the following detailed description of various embodiments of the present disclosure read in conjunction with the accompanying drawings. The detailed description and drawings are merely illustrative of the present disclosure rather than limiting, the scope of the present disclosure being defined by the appended claims and equivalents thereof

### BRIEF DESCRIPTION OF THE DRAWINGS

FIG. 1 illustrates an exemplary embodiment of a physical world in accordance with the inventive principles of the present disclosure.

FIG. 2 illustrate exemplary embodiments of an enhanced augmented reality device in accordance with the inventive principles of the present disclosure.

FIGS. 3A-3I illustrates exemplary embodiments of prior art markers in accordance with the inventive principles of the present disclosure.

FIGS. 4A-4D illustrates exemplary embodiments of prior art sensors in accordance with the inventive principles of the present disclosure.

FIGS. 5A-5H illustrates exemplary positioning of a virtual object within an augmented reality display in accordance with the inventive principles of the present disclosure.

FIG. 6 illustrates an exemplary embodiments of authorized zones and forbidden zones in accordance with the inventive principles of the present disclosure.

FIG. 7 illustrates exemplary embodiments of an enhanced augmented reality method in accordance with the inventive principles of the present disclosure.

FIG. 8 illustrates exemplary embodiments of a decisive aggregation method in accordance with the inventive principles of the present disclosure.

FIG. 9 illustrates exemplary embodiments of a virtual object positioning controller in accordance with the inventive principles of the present disclosure.

### DETAILED DESCRIPTION OF THE PREFERRED EMBODIMENTS

Generally, enhanced augmented reality devices and methods of the present disclosure generally involve a live view of physical objects in a physical world via eye(s), a camera, a smart phone, a tablet, etc. that is augmented with information embodied as displayed virtual objects in the form of virtual content/links to content (e.g., images, text, graphics, video, thumbnails, protocols/recipes, programs/scripts, etc.) and/or virtual items (e.g., a 2D screen, a hologram, and a virtual representation of a physical object in the virtual world).

More particularly, a live video feed of the physical world facilitates a mapping of a virtual world to the physical world whereby computer generated virtual objects of the virtual world are positionally overlaid on a live view of the physical objects in the physical world. The enhanced augmented reality devices and methods of the present disclosure provide a controller autonomous positioning of a virtual object relative to an augmented reality display view of a physical object within a physical world.

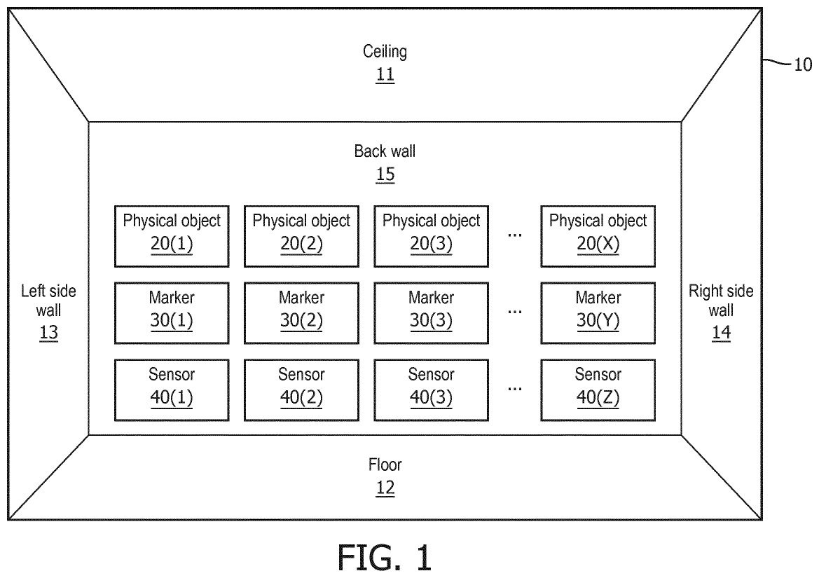

To facilitate an understanding of the various inventions of the present disclosure, the following description of FIG. 1 teaches an exemplary frontal view of a physical world by an enhanced augmented reality device of the present disclosure. While the physical world will be described in the context of a room 10, those having ordinary skill in the art of the present disclosure will appreciate how to apply the inventive principles of the present disclosure to a physical world in any context.

Referring to FIG. 1, the frontal view of physical world 10 by an enhanced augmented reality device of the present disclosure spans a celling 11, a floor 12, a left side wall 13, a right side wall 14, and a back wall 15.

An X number of physical objects 20 are within the frontal view of physical world 10 by an enhanced augmented reality device of the present disclosure, X >1. In practice, for the enhanced augmented reality devices and methods of the present disclosure, a physical object 20 is any view of information via a physical display, bulletin boards, etc. (not shown) in the form of content/links to content (e.g., text, graphics, video, thumbnails, etc.), any physical item (e.g., physical devices and physical systems), and/or any physical entity (e.g., a person). In a context of physical world 10 being a clinical/operating room, examples of physical objects 20 include, but are not limited to:
1. a physician, associated staff and a patient;
2. a physical screen with displayed images of a patient anatomy;
3. a table-side monitor with displayed graphics of a tracked path of a tool/instrument through the patient anatomy;
4. a displayed video of a previous execution of the medical procedure;
5. a displayed thumbnail linked to text, graphics or a video;
6. any medical devices and/or apparatuses for performing the medical procedure (e.g., an x-ray system, an ultrasound system, a patient monitoring system, anaesthesia equipment, the patient bed, a contrast injection system, a table-side control panel, a sound system, a lighting system, a robot, a monitor, a touch screen, a tablet, a phone, medical equipment/tools/instruments, additional augmented reality devices and workstations running medical software like image processing, reconstruction, image fusion, etc.); and
7. additional enhanced augmented reality devices of the present disclosure.

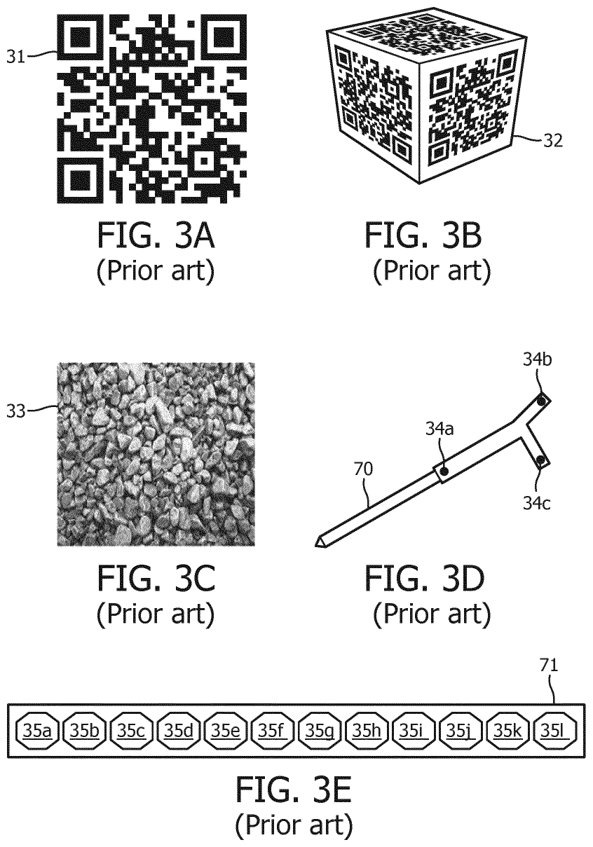

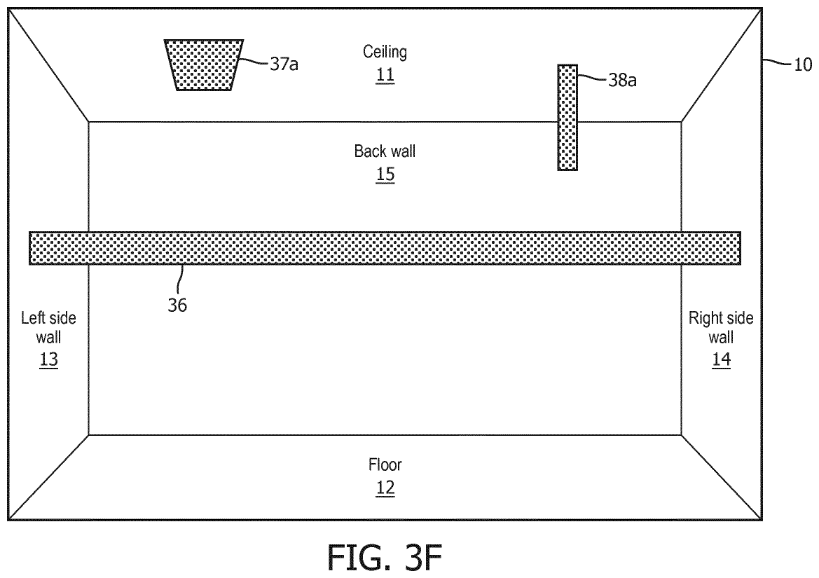

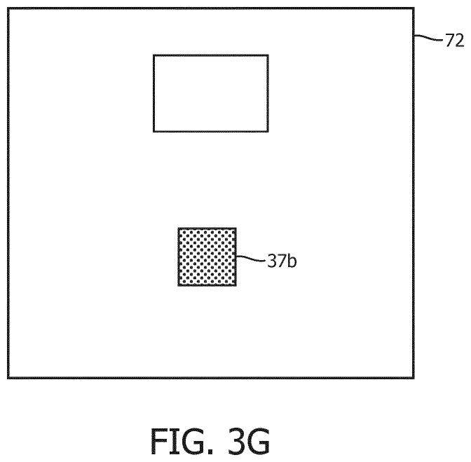

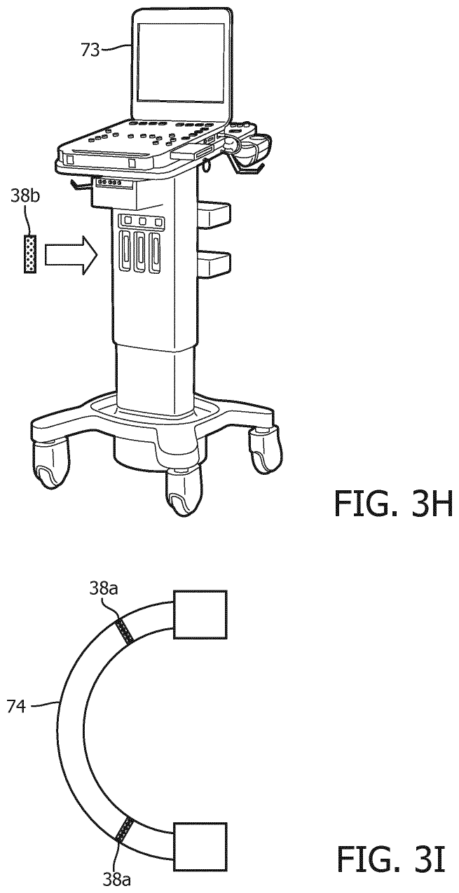

Still referring to FIG. 1, a Y number of markers 30 may be within the frontal view of physical world 10 by an enhanced augmented reality device of the present disclosure, Y >0. In practice, for the enhanced augmented reality devices and methods of the present disclosure, a marker 30 is a physical object 20 designated within physical world 10 for facilitating a spatial mapping of physical world 10 and/or for facilitating a tracking of a physical object 20 within physical world 10. Examples of markers 30 include, but are not limited to one or more of:
1. a two-dimensional (“2D”) QR marker 31 as shown in FIG. 3A;
2. a three-dimensional (“3D”) QR marker 32 as shown in FIG. 3B;
3. a pattern marker 33 as shown in FIG. 3C;
4. optical tracking markers 34a-34c attached to a medical instrument 70 as shown in FIG. 3D;
5. a defined 3D shape of an object;
6. a label, logo, or other similar feature on an object; and
7. a pattern 71 of LEDs 35a-35i as shown in FIG. 3E.

In practice, marker(s) 30 may be mounted, affixed, arranged or otherwise positioned within physical world 10 in any manner suitable for a spatial mapping of physical world 10 and/or a tracking of physical object(s). In the context of physical world 10 being a clinical/operating room, examples of positioning a marker 30 within clinical/operating room include, but are not limited to:
1. A marker band 35 that runs around the circumference of walls 13-15 of physical world 10 at roughly eye-level as shown in FIG. 3F to thereby be visible in almost any augmented reality view of physical world 10. Additionally or alternatively, a marker band can be positioned on the floor or the ceiling of physical world (not shown);
2. A marker 37a painted on celling 11 as shown in FIG. 3F (alternative or additional marker(s) may be painted on walls 13-15);
3. A marker 38a that is physically attached to celling 11 as shown in FIG. 3F (alternative or additional marker(s) may be physically attached to walls 13-15);
4. A marker 37b that is embedded into a sterile drape 72 in the form of a sterile sticker or as directly printed/embedded in the drape 72 as shown in FIG. 3G;
5. A clip-on marker 38b attached to a physical object 20, such as, for example, a patient table, medical equipment (e.g., an ultrasound scanner 73 as shown in FIG. 3H, an ultrasound probe, a robot, a contrast injector, etc.), a computer/display screen and an additional enhanced augmented reality device of the present disclosure; and
6. A pattern 38a and 38b of LEDs incorporated into the x-ray detector 74 as shown in FIG. 3I.

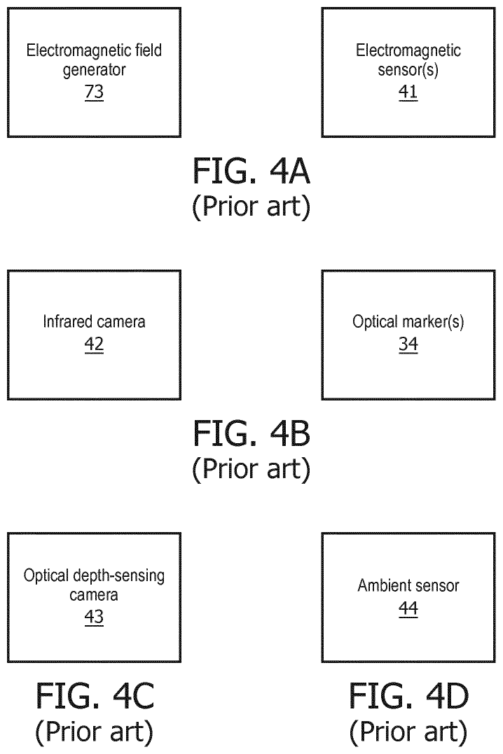

Still referring to FIG. 1, a Z number of sensors 40 may be within the frontal view of physical world 10 by an enhanced augmented reality device of the present disclosure, Z≥0. In practice, for the enhanced augmented reality devices and methods of the present disclosure, a sensor 40 is a physical object 20 designated within physical world 10 for facilitating a sensing of a physical object 20 within physical world 10. Examples of sensors 40 include, but are not limited to:
1. as shown in FIG. 4A, electromagnetic sensor(s) 41 affixable and/or integrated with a physical object 20 whereby an electromagnetic field generator 73 may be operated to sense the pose and/or shape of a physical object 20 within physical world 10;
2. as shown in FIG. 4B, an infrared camera 42 for sensing optical markers 34 affixable and/or integrated with a physical object 20 (e.g., optical markers 34a-34c of FIG. 3D) whereby infrared camera 42 may be operated to sense a physical object 20 within physical world 10;
3. an optical depth-sensing camera 43 for visualizing physical object(s) 20 within physical world 10; and
4. an ambient sensor 44 for sensing an ambient condition of physical world 10 (e.g., a temperature sensor, a humidity sensor, a light sensor, etc.).

In practice, sensor(s) 40 may be mounted, affixed, arranged or otherwise positioned within physical world 10 in any manner suitable for sensing of a physical object 20 within physical world 10.

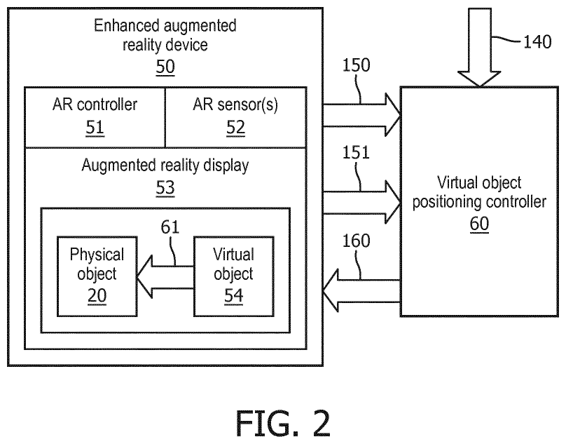

To facilitate a further understanding of the various inventions of the present disclosure, the following description of FIG. 2 teaches exemplary enhanced augmented reality devices of the present disclosure. From the description, those having ordinary skill in the art of the present disclosure will appreciate how to apply the inventive principles of the present disclosure for making and using additional embodiments of enhanced augmented reality devices of the present disclosure.

Referring to FIG. 2, an enhanced augmented reality device 50 of the present disclosure employs an augmented reality controller 51, an augmented reality sensor(s) 52, an augmented reality display 53 and interactive tools/mechanisms (not shown) (e.g., gesture recognition (including totems), voice commands, head tracking, eye tracking and totems (like a mouse)) as known in the art of the present disclosure for generating and displaying virtual object(s) relative to a live view of a physical world including physical objects to thereby augment the live view of the physical world.

In practice, for the purpose of spatial mapping of physical world 10 and physical object/marker tracking, augmented reality sensor(s) 52 may include RGB or grayscale camera(s), depth sensing camera(s), IR sensor(s), accelerometer(s), gyroscope(s), and/or upward-looking camera(s).

In practice, for the enhanced augmented reality methods of the present disclosure, a virtual object is any computer-generated display of information via augmented reality display 53 in the form of virtual content/links to content (e.g., images, text, graphics, video, thumbnails, protocols/recipes, programs/scripts, etc.) and/or virtual items (e.g., a hologram and a virtual representation of a physical object in the virtual world). For example, in a context of a medical procedure, a virtual object may include, but not be limited to:
1. displayed text of a configuration of a medical imaging apparatus;
2. displayed graphics of a planned path with respect to a patient anatomy;
3. a displayed video of a previous recording of a live view of the medical procedure;
4. a displayed thumbnail linked to a text, graphics or a video;
5. a hologram of a portion or an entirety of a patient anatomy;
6. a virtual representation of a surgical robot;
7. a live image feed from a medical imager (ultrasound, interventional x-ray, etc.);
8. live data traces from monitoring equipment (e.g., an ECG monitor);
9. live images of any screen display;
10. a displayed video (or auditory) connection to a third party (e.g., another augmented reality device wearer in a different room, medical personal via webcam in their office and equipment remote support);
11. a recalled position of an object visualized as either text, an icon, or a hologram of the object in that stored position;
12. a visual inventory of medical devices available or suggested for a given procedure; and
13. a virtual representation of a remote person assisting with the procedure.

Still referring to FIG. 2, a virtual object positioning controller 60 of the present disclosure is linked to or housed within enhanced augmented reality device 50 to enhance a positioning of the virtual object within the augmented reality display 51. Alternatively, virtual object positioning controller 60 may be incorporated within augmented reality controller 51.

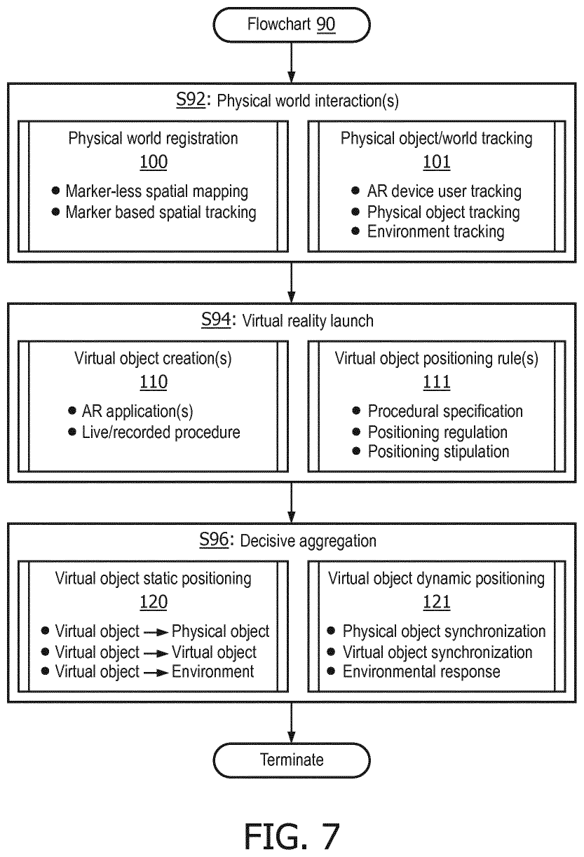

In operation, virtual object positioning controller 60 inputs signals/data 140 from sensor(s) 40 informative of a sensing of physical world 10 by sensor(s) 40. Virtual object positioning controller 60 further inputs signals/data/commands 150 from augmented reality controller 51 informative of an operation/display status of enhanced augmented reality device 50 and signals/data/commands 151 from augmented reality sensor(s) 52 informative of a sensing of physical world 10 by sensor(s) 52. In turn, as will be further explained with the description of FIG. 7, virtual object positioning controller 60 communicates signals/data/commands 160 to augmented reality controller 51 and/or augmented reality display 53 for autonomously positioning 61 a virtual object 55 relative to an augmented reality display view of a physical object 20 within physical world 10.

In practice, a virtual object 54 may be positioned relative to an augmented reality display view of a physical object 20 within physical world 10 in one or more positioning modes.

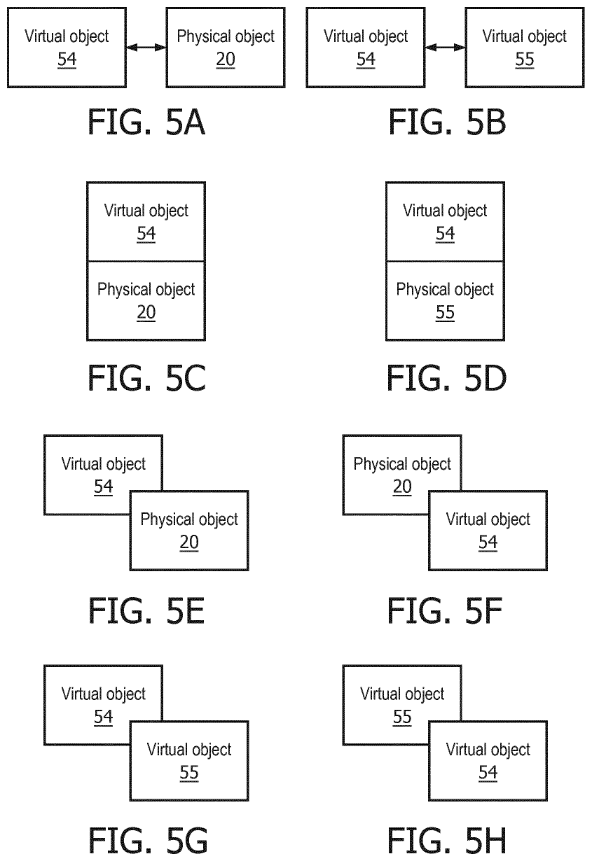

In one positioning mode, as shown in FIG. 5A, virtual object 54 may be spaced from a physical object 20 at a fixed or variable distance in accordance with a specified use of physical object 20 or a procedure involving physical object 20.

In a second positioning mode, as shown in FIG. 5B, virtual object 54 may be spaced from an additional virtual object 55 at a fixed or variable distance in accordance with a specified use of physical object 20 or a procedure involving physical object 20.

In a third positioning mode, as shown in FIG. 5C, virtual object 54 may be arranged onto any surface of physical object 20 in a manner appropriate for a specified use of physical object 20 or a procedure involving physical object 20.

In a fourth positioning mode, as shown in FIG. 5C, an additional virtual object 55 may be arranged onto any surface of virtual object 54 in a manner appropriate for a specified use of physical object 20 or a procedure involving physical object 20.

In a fifth positioning mode, as shown in FIG. 5E, a portion or an entirety of virtual object 54 may be positioned behind physical object 20 whereby physical object 20 blocks a visualization of such portion of virtual object 54 or an entirety of virtual object 54. For this mode, virtual object 54 may stay positioned behind physical object 20, or virtual object 54 may alternatively be moved within augmented reality display 53 for any occlusion by physical object 20 or for an occlusion by physical object 20 to an unacceptable degree.

In a sixth positioning mode, as shown in FIG. 5F, a portion or an entirety of virtual object 54 may be positioned in front of physical object 20 whereby virtual object 54 blocks a visualization of such portion of physical object 20 or an entirety of physical object 20. For this mode, virtual object 54 may stay positioned in front of physical object 20, or virtual object 54 may alternatively be moved within augmented reality display 53 for any occlusion by virtual object 54 or an occlusion by virtual object 54 to an unacceptable degree.

In a seventh positioning mode, as shown in FIG. 5G, a portion or an entirety of virtual object 54 may be positioned behind an additional virtual object 55 whereby virtual object 55 blocks a visualization of such portion of virtual object 54 or an entirety of virtual object 54. For this mode, virtual object 54 may stay positioned behind virtual object 55, or virtual object 54 may alternatively be moved within augmented reality display 53 for any occlusion by virtual object 55 or for an occlusion by virtual object 55 to an unacceptable degree,.

In an eighth positioning mode, as shown in FIG. 5H, a portion or an entirety of virtual object 54 may be positioned in front of an additional virtual object 55 whereby virtual object 54 blocks a visualization of such portion of virtual object 55 or an entirety of virtual object 55. For this mode, virtual object 54 may stay positioned in front of virtual object 55, or either virtual object 54 or virtual object 55 may alternatively be moved within augmented reality display 53 for any occlusion by virtual object 54 or for an occlusion by virtual object 54 to an unacceptable degree.

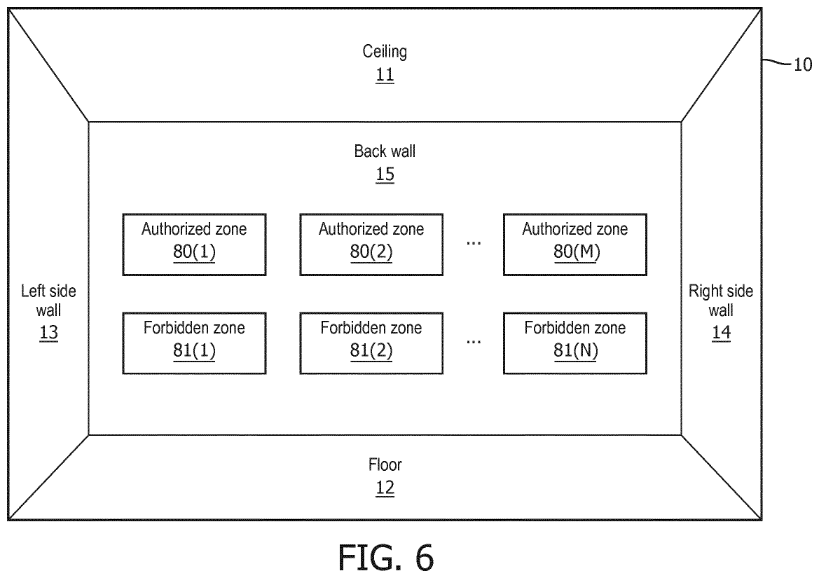

In a ninth positioning mode, as shown in FIG. 6, virtual object 54 may only be positioned within any spatial area of physical world 10 or only within a M number of authorization zones 80 of physical world 10, M≥0. Concurrently or alternatively, virtual object 54 may not be positioned within a N number of forbidden zones 81 of physical world 10, N≥0.

For all positioning modes, any translational/rotational/pivoting movement of virtual object 54 and/or any translational/rotational/pivoting movement of virtual object 55 within augmented reality display 53 may be synchronized with any translational/rotational/pivoting movement of the physical object 20 to maintain the positioning relationship to the greatest extent possible.

Furthermore, for all positioning modes, virtual object 54 and/or virtual object 55 may be reoriented and/or resized to maintain the positioning relationship to the greatest extent possible.

The aforementioned positioning modes will be further described in the description of FIG. 7.

To facilitate a further understanding of the various inventions of the present disclosure, the following description of FIG. 7 teaches exemplary embodiments of an enhanced augmented reality method of the present disclosure. From this description, those having ordinary skill in the art will appreciate how to apply the inventive principles of the present disclosure for making and using additional embodiments of an enhanced augmented reality method of the present disclosure. While FIG. 7 will be described in the context of physical world 10 as shown in FIG. 1, those having ordinary skill in the art of the present disclosure will appreciate how to apply the inventive principles enhanced augmented reality method of the present disclosure to a physical world in any context.

Referring to FIG. 7, a flowchart 90 represents exemplary embodiments of an enhanced augmented reality method of the present disclosure.

Generally, a stage S92 of flowchart 90 encompasses physical world interactions with and sensor(s) 40 (FIG. 1) and augmented reality camera 52 (FIG. 2). More particularly, stage S92 implements a physical world registration involving a marker-less spatial mapping and/or a marker-based spatial mapping of the physical world to enable a positioning by virtual object positioning controller 60 of a virtual object 54 relative to the surface(s) of physical object 20.

In practice, the marker-less spatial mapping provides a detailed representation of real-world surfaces in the environment around enhanced augmented reality device 50 (FIG. 1) as observed by augmented reality glasses 52. Specifically, the marker-less spatial mapping provides one or more bounding volumes to enable a wearer of enhanced augmented reality device 50 to define the regions of space within physical world 10 whereby spatial surface(s) of physical object(s) 20 are provided for the or each bounding volume. The bounding volume(s) may be stationary (in a fixed location with respect to the physical world) or attached enhanced augmented reality device 50. Each spatial surface describes surface(s) of a physical object 20 in a small volume of space represented as a triangle mesh attached to a world-locked coordinate system.

In practice, the marker-based spatial mapping may be executed in several modes.

In a single marker tracking mode, a position of virtual object 54 (e.g., a hologram) within the virtual world of augmented reality display 53 is tied to a tracking by augmented reality sensor(s) 52 of any visible single marker 30 within physical world 10 (e.g., one of markers 31-39 as shown in FIGS. 3A-3G visible in the view of augmented reality sensor(s) 52).

In a nested marker tracking mode, a position of virtual object 54 (e.g., a hologram) within the virtual world of augmented reality display 53 is tied to a tracking by augmented reality sensor(s) 52 of a specifically designated single marker 30 within physical world 10 (e.g., one of markers 31-39 as shown in FIGS. 3A-3G specifically designated as the registration marker).

In a multi-marker tracking mode, a position of more than one marker 30 within physical world 30 is utilized to determine a position of virtual object 54 (e.g., a hologram) within the virtual world of augmented reality display 53. For example, The multiple markers 30 may be used simply to improve registration of virtual object 54 in a fixed space of physical world 10. By further example, a first marker 30 on a robot that is moving an imaging probe (e.g. an endoscope) with respect to a patient, and a second marker 30 on a drape covering the patient may be used to determine a position of virtual object 54 (e.g., a hologram) within the virtual world of augmented reality display 5 whereby a hologram of an intra-operative endoscope image may be displayed relative to both the robot and the patient.

In a multi-modality tracking mode, a localization of the augmented reality display 53 uses external sensors 40 in physical world 10 (e.g., multiple cameras triangulating a position of virtual object 54 in physical world 10, RFID trackers, smart wireless meshing etc.). The localization is communicated to virtual object positioning controller 60 to look for predetermined specific physical object(s) 20 and/or specific marker(s) 30 in the vicinity. The virtual object positioning controller 60 may use computationally intensive algorithms to conduct spatial mapping at finer resolution.

Still referring to FIG. 7, stage S92 further implements a physical world tracking 101 involving a tracking of user of enhanced augmented reality device 50, a tracking of a physical object 20 within physical world 10, a tracking of a marker 30 within physical world 10, and/or a tracking an ambient condition of physical world 10.

For user tracking, user information tracked by augmented reality sensor(s) 52 include, but are not limited to, head pose, hand positions and gestures, eye tracking, and position of the user in the spatial mapping of physical world 10. Additional information about the user may be tracked from external sensors 40, such as, for example, a camera mounted in the room to detect position of the torso of the user.

For physical object tracking, object recognition techniques are executed for the recognition of specific physical object(s) 20, such as, for example, a c-arm detector, table-side control panels, an ultrasound probe, tools and a patient table. Physical object(s) 20 may be recognized by shape as detected in the spatial mapping, from optical marker tracking, from localization within the spatial mapping (e.g., via a second enhanced augmented reality device 40), or from external tracking (e.g., an optical or electromagnetic tracking system). Physical object tracking may further encompass object detection to specifically detect people within the physical world and to also identify a particular person via facial recognition. Physical object tracking may also incorporate knowledge of encoded movement of objects (e.g. c-arm or table position, robots, etc.).

Environment tracking may encompass a sensing of ambient light and/or a background light and/or background color within the physical world 10 by sensor(s) 40 and/or sensor(s) 52 and/or a sensing of an ambient temperature or humidity level by sensor(s) 40 and/or sensor(s) 52.

Still referring to FIG. 7, a stage S94 of flowchart 90 encompasses a virtual reality launch involving a creation of virtual objects(s) 54.

In one embodiment, virtual objects are created via live or recorded procedures performed within physical world 10, such as, for example (1) live content (e.g., image streams, patient monitors, dose information, a telepresence chat window), (2) pre-operative content (e.g., a segmented CT scan as a hologram, a patient record, a planned procedure path), and (3) intra-operative content (e.g., a saved position of a piece of equipment to return to later, an annotation of an important landmark, a saved camera image from the AR glasses or x-ray image to use as a reference).

In a second embodiment, virtual object(s) are created via augmented reality application(s).

The virtual reality launch of stage S94 further encompasses a delineation of virtual object positioning rule(s) including, but not limited to, procedural specification(s), positioning regulations and positioning stipulations.

In practice, procedural specification(s) encompass a positioning of the virtual object relative to a view of a physical object as specified by an AR application or a live/recorded procedure. For example, an X-ray procedure may specify a positioning of an xperCT reconstruction hologram at a c-arm isocenter based on a detection of a position of the c-arm using the underlying spatial mapping of the room. By further example, an ultrasound procedure may specify a virtual ultrasound screen be positioned to a space that is within five (5) centimeters of a transducer but not overlapping with a patient, probe, or user's hands. The ultrasound procedure may further specify virtual ultrasound screen is also tilted so that it is facing the user.

Virtual controls or buttons can snap to a physical object. The buttons automatically locate themselves to be most visible to the user.

In practice, positioning regulations encompass a positioning of the virtual object relative to a view of a physical object as mandated by a regulatory requirement associated with an AR application or a live/recorded procedure. For example, for fluoroscopy, whenever there are x-rays present, fluoroscopy regulations may mandate an image should always be displayed in the field-of-view.

Additionally or alternatively, positioning regulations encompass a positioning of the virtual object based on a field of view of the display of the augmented reality display 53. Said field of view may take into account number of parameters of the augmented reality display 50 or the augmented reality device 50, or both, such as, without limitation the optimal focal depth, the sizing of virtual windows, chromatic aberrations or other optical features of the display, such as knowledge of eye gaze patterns of the wearer

In practice, positioning stipulations encompass a positioning of the virtual object relative to a view of a physical object as stipulated as a user of enhanced augmented reality device 50. For example, via a graphical user interface or AR user interface, a user may stipulate authorized zone(s) 80 and/or forbidden zone(s) 81 as shown in FIG. 1. By further example, via a graphical user interface, the user may stipulate a minimum distance of the virtual object from physical object(s) and/or provide prioritization rules between types of virtual content. These rules may defined explicitly by the user or learned.

Still referring to FIG. 7, a stage S96 of flowchart 90 encompasses exemplary embodiments of decisive aggregation of information and data to position the virtual object 54 relative to a view of the physical object 20 within augmented reality display 53. Specifically, stage S96 includes a virtual object static positioning 120 involving position of the virtual object 54 relative to a view of the physical object 20 within augmented reality display 53 that may or may not take into account position(s) of additional virtual objects within augmented reality display 53 and/or an operating environment of augmented reality display 53. Stage S96 may further include a virtual object dynamic positioning 121 involving a movement synchronization of the virtual object 54 with a physical object 20, another virtual object and/or operating environment changes.

In practice of stage S96, virtual object positioning controller 60 may automatically position the virtual object 54 relative to a view of the physical object 20 within augmented reality display 53. Alternatively or concurrently in practice of stage S96, virtual object positioning controller 60 may provide a recommendation of a positioning of the virtual object 54 relative to a view of the physical object 20 within augmented reality display 53, which may be accepted or declines. Further in practice of stage S96, at the conclusion of any corresponding procedure, virtual object positioning controller 60 may update a layout settings of AR display 53 based on any accepted or rejected recommendation.

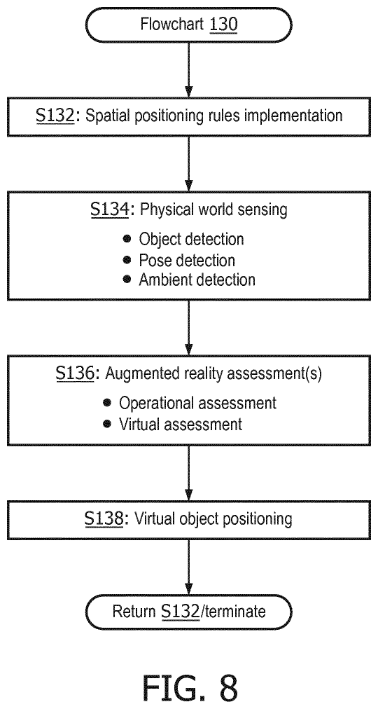

In one embodiment, a decisive aggregation method of the present disclosure is executed during stage S96. Referring to FIG. 8, a flowchart 130 is representative of a decisive aggregation method of the present disclosure.

A stage S132 of flowchart 130 encompasses controller 60 implementing procedural specification(s), position regulation(s) and/or position stipulation(s) as previously described in the present disclosure. More particularly, the procedural specification(s) will be informative of physical object(s) to be detected, position regulation(s) will be informative any mandated virtual object positioning and the position stipulations(s) may be informative of authorized zone(s) and/or forbidden zone(s), and minimal distance thresholds between objects.

A stage S134 of flowchart 130 encompasses controller 60 processing information and data related to a sensing of the physical world.

In one embodiment of stage S134, the sensing of the physical world includes an object detection involving a recognition of specific physical objects as set forth in the stage S132, such as, for example in a clinical/medical context, a c-arm detector, table-side control panels, an ultrasound probe, tools and a patient table. In practice, controller 60 may recognize a shape of the physical objects as detected in a spatial mapping of stage S92 (FIG. 7), from optical marker tracking of stage S92, from a self-localization within the same spatial mapping (e.g. like a second head-mounted display), or via external tracking (e.g., a optical or electromagnetic tracking system) of stage S92.

Additionally in practice, controller may recognize individual(s), more particularly identify an identity of individual(s) via facial recognition.

In a second embodiment of stage S134, the sensing of the physical world includes a pose detection of the augmented reality display 53 relative to physical world 10. In practice controller 60 may track, via AR sensors 52, a head pose, hand positions and gestures, eye tracking, and a position of a user in the mesh of the physical world. Additional information about the user can be tracked from external sensors, such as, for example, a camera mounted in the physical world 10 to detect position of a specific body part of the user (e.g., a torso).

In a third embodiment of stage S134, the sensing of the physical world includes an ambient detection of an operating environment of augmented reality display 53. In practice, controller 60 may monitor a sensing of an ambient light, or a background light, or a background color within the physical world, and may adjust a positioning specification of the virtual object to ensure visibility within augmented reality display 53.

A stage S136 of flowchart 130 encompasses controller 60 processing information and data related to an assessment of the augmented reality of the procedure.

In one embodiment of stage S136, the augmented reality assessment includes operational assessment of augmented reality display 53. In practice, controller 60 may take into account a field of view of the physical world or a virtual world by the augmented reality display 53, focal planes of the augmented reality display 53, a sizing of the window to account for text readability, and field of view of the physical world by the augmented reality display (53).

In an exemplary embodiment, the detected or assessed background color is used to adjust a positioning of a specification of the virtual object to ensure visibility within augmented reality display 53. In an exemplary implantation of such exemplary embodiment, the controller 60 comprises or is coupled with an edge detection algorithm on the camera feed, further configured to detect uniformity of the background colour by applying a predefined threshold on each of, or some of the pixels of the augmented reality display, wherein such edge detection may output a signal indicative of the color, or the color uniformity of the background. Additionally or alternatively, the controller 60 comprises a RGB color value determination means capable of assessing and determining the distribution of colors across the image of the augmented reality display (53). Additionally or alternatively, the controller 60 comprises means to look at the contrast of the background image such as to find the region of the background that has the best contrast with the color of the displayed virtual content.

In a second embodiment of stage S136, the augmented reality assessment includes a virtual assessment of a positioning of additional virtual objects. In practice, controller 60 may snap one virtual object next to another virtual object, or may keep one virtual object away from another virtual content so as not to interfere.

A stage S138 of flowchart 130 encompasses positioning the virtual object 54 within the augmented reality display 53. In practice, when initially deciding where to place the virtual object 54 within augmented reality display 53, the controller 60 must take into account all of the information and data from stages S132-S136 and delineates a position for the virtual object 54 relative to the physical object(s) 20 for a functional visualization by a user of the AR device 50 (e.g., positions as shown in FIGS. 5A-5H).

Once the virtual object is positioned within the display, controller 60 loops through stages S134-S138 to constantly controlling the position and visibility based on any changes to the physical world and/or movements of physical objects. More particularly, when a virtual object interacts with a physical object, a few scenarios may occur.

First, the virtual object may obscure a moving physical object. For example, a C-arm may be moved whereby the c-arm occupies the same space as a X-ray virtual screen, which is to be always displayed based on a regulatory rule. In the same example, a patient information virtual screen may be hidden behind the C-arm based on a user prioritization.

Second, a physical object may obscure the virtual object. For example, a patient is physically disposed in a virtual screen, whereby the virtual screen may be hidden so the patient may be seen via the display or the virtual screen is obscured only in the region where the patient exists.

Third, the virtual object readjusts to accommodate the physical object. For example, a virtual screen is adjacent a user hands, and any movement of the hands blocking the virtual screen results in the virtual screen automatically being repositioned so that both the virtual screen and hands are visible in the field-of-view of the display device. By further example, a light is turned on behind the virtual screen whereby the virtual screen is automatically brighted to adapt to the light.

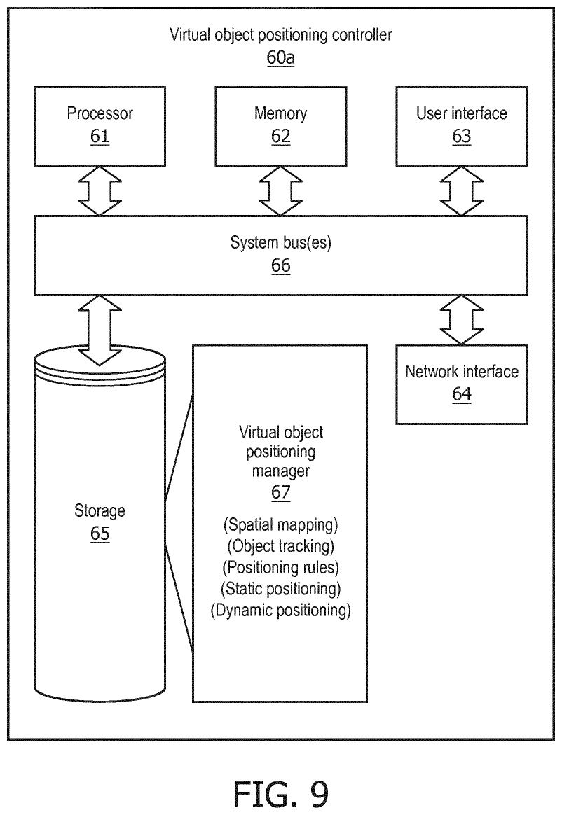

To facilitate a further understanding of the various inventions of the present disclosure, the following description of FIG. 9 teaches an exemplary embodiment of a virtual object positioning controller of the present disclosure. From this description, those having ordinary skill in the art will appreciate how to apply the inventive principles of the present disclosure for making and using additional embodiments of a virtual object positioning controller of the present disclosure.

Still referring to FIG. 9, a virtual object positioning controller 60a includes one or more processor(s) 61, memory 62, a user interface 63, a network interface 64, and a storage 65 interconnected via one or more system buses 66.

Each processor 61 may be any hardware device, as known in the art of the present disclosure or hereinafter conceived, capable of executing instructions stored in memory 62 or storage or otherwise processing data. In a non-limiting example, the processor(s) 61 may include a microprocessor, field programmable gate array (FPGA), application-specific integrated circuit (ASIC), or other similar devices.

The memory 62 may include various memories, as known in the art of the present disclosure or hereinafter conceived, including, but not limited to, L1, L2, or L3 cache or system memory. In a non-limiting example, the memory 62 may include static random access memory (SRAM), dynamic RAM (DRAM), flash memory, read only memory (ROM), or other similar memory devices.

The user interface 63 may include one or more devices, as known in the art of the present disclosure or hereinafter conceived, for enabling communication with a user such as an administrator. In a non-limiting example, the user interface may include a command line interface or graphical user interface that may be presented to a remote terminal via the network interface 64.

The network interface 64 may include one or more devices, as known in the art of the present disclosure or hereinafter conceived, for enabling communication with other hardware devices. In an non-limiting example, the network interface 64 may include a network interface card (MC) configured to communicate according to the Ethernet protocol. Additionally, the network interface 64 may implement a TCP/IP stack for communication according to the TCP/IP protocols. Various alternative or additional hardware or configurations for the network interface 64 will be apparent. The storage 65 may include one or more machine-readable storage media, as known in the art of the present disclosure or hereinafter conceived, including, but not limited to, read-only memory (ROM), random-access memory (RAM), magnetic disk storage media, optical storage media, flash-memory devices, or similar storage media. In various non-limiting embodiments, the storage 65 may store instructions for execution by the processor(s) 61 or data upon with the processor(s) 61may operate. For example, the storage 65 may store a base operating system for controlling various basic operations of the hardware. The storage 65 also stores application modules in the form of executable software/firmware for implementing the various functions of the controller 60a as previously described in the present disclosure including, but not limited to, a virtual object positioning manager 67 implementing spatial mapping, spatial registration, object tracking, object recognition, positioning rules, static positioning and dynamic positioning as previously described in the present disclosure.

Referring to FIGS. 1-9, those having ordinary skill in the art of the present disclosure will appreciate numerous benefits of the present disclosure including, but not limited to, a controller autonomous positioning of a virtual object relative to an augmented reality display view of a physical object within a physical world.

Further, as one having ordinary skill in the art will appreciate in view of the teachings provided herein, structures, elements, components, etc. described in the present disclosure/specification and/or depicted in the Figures may be implemented in various combinations of hardware and software, and provide functions which may be combined in a single element or multiple elements. For example, the functions of the various structures, elements, components, etc. shown/illustrated/depicted in the Figures can be provided through the use of dedicated hardware as well as hardware capable of executing software in association with appropriate software for added functionality. When provided by a processor, the functions can be provided by a single dedicated processor, by a single shared processor, or by a plurality of individual processors, some of which can be shared and/or multiplexed. Moreover, explicit use of the term “processor” or “controller” should not be construed to refer exclusively to hardware capable of executing software, and can implicitly include, without limitation, digital signal processor (“DSP”) hardware, memory (e.g., read only memory (“ROM”) for storing software, random access memory (“RAM”), non-volatile storage, etc.) and virtually any means and/or machine (including hardware, software, firmware, combinations thereof, etc.) which is capable of (and/or configurable) to perform and/or control a process.

Moreover, all statements herein reciting principles, aspects, and embodiments of the invention, as well as specific examples thereof, are intended to encompass both structural and functional equivalents thereof Additionally, it is intended that such equivalents include both currently known equivalents as well as equivalents developed in the future (e.g., any elements developed that can perform the same or substantially similar function, regardless of structure). Thus, for example, it will be appreciated by one having ordinary skill in the art in view of the teachings provided herein that any block diagrams presented herein can represent conceptual views of illustrative system components and/or circuitry embodying the principles of the invention. Similarly, one having ordinary skill in the art should appreciate in view of the teachings provided herein that any flow charts, flow diagrams and the like can represent various processes which can be substantially represented in computer readable storage media and so executed by a computer, processor or other device with processing capabilities, whether or not such computer or processor is explicitly shown.

Having described preferred and exemplary embodiments of the various and numerous inventions of the present disclosure (which embodiments are intended to be illustrative and not limiting), it is noted that modifications and variations can be made by persons skilled in the art in light of the teachings provided herein, including the Figures. It is therefore to be understood that changes can be made in/to the preferred and exemplary embodiments of the present disclosure which are within the scope of the embodiments disclosed herein.

Moreover, it is contemplated that corresponding and/or related systems incorporating and/or implementing the device/system or such as may be used/implemented in/with a device in accordance with the present disclosure are also contemplated and considered to be within the scope of the present disclosure. Further, corresponding and/or related method for manufacturing and/or using a device and/or system in accordance with the present disclosure are also contemplated and considered to be within the scope of the present disclosure.

1. An augmented reality device (50), comprising:
an augmented reality display (53) operable to display a virtual object relative to a view of at least one physical object within a physical world; and
a virtual object positioning controller (60) configured to autonomously control a positioning of the virtual object within the augmented reality display (53) based on a decisive aggregation of:
an implementation, by the virtual object positioning controller (60), of at least one spatial positioning rule regulating the positioning of the virtual object within the augmented reality display (53); and
a sensing of the physical world.

2. The augmented reality device (50) of claim 1, wherein the sensing of the physical world includes an object detection, by the virtual object positioning controller (60), of the at least one physical object within the physical world.

3. The augmented reality device (50) of claim 1, wherein the sensing of the physical world includes a pose detection, by the virtual object positioning controller (60), of the augmented reality display (53) relative to the physical world.

4. The augmented reality device (50) of claim 1, wherein the sensing of the physical world includes an ambient detection, by the virtual object positioning controller (60), of an operating environment of the augmented reality display (53) relative to the physical world.

5. The augmented reality device (50) of claim 1, wherein the virtual object positioning controller (60) is further configured to autonomously control the positioning of the virtual object within the augmented reality display (53) based on the decisive aggregation further includes an operational assessment, by the virtual object positioning controller (60), of at least one technical specification of the augmented reality display (53).

6. The augmented reality device (50) of claim 1, wherein the virtual object positioning controller (60) is further configured to autonomously control the positioning of the virtual object within the augmented reality display (53) based on the decisive aggregation further includes a virtual assessment, by the virtual object positioning controller (60), of a positioning of one or each of at least one additional virtual object within the augmented reality display (53).

7. The augmented reality device (50) of claim 1, wherein the virtual object positioning controller (60) is further configured to autonomously control the positioning of the virtual object within the augmented reality display (53) based on one of:
a marker-less spatial mapping, by the virtual object positioning controller (60), of the physical world derived from the view of the at least one physical object within the physical world; and
a marked-based spatial mapping, by the virtual object positioning controller (60), of the physical world derived from a sensing of at least one marker within the physical world.

8. The augmented reality device (50) of claim 7, wherein the marked-based spatial mapping includes at least one of a single marker tracking, a nested marker tracking, a multi-marker tracking and a multi-modality tracking.

9. A non-transitory machine-readable storage medium encoded with instructions for execution by at least one processor (81), the non-transitory machine-readable storage medium comprising instructions to:
autonomously control a positioning of a virtual object within an augmented reality display (53) displaying the virtual object relative to a view of a physical object within a physical world based on a decisive aggregation of:
an implementation of at least one spatial positioning rule regulating the positioning of the virtual object within the augmented reality display (53); and a sensing of the physical world; and
a sensing of the physical world.

10. The non-transitory machine-readable storage medium of claim 1, wherein the sensing of the physical world includes instructions to execute an object detection of the at least one physical object within the physical world.

11. The non-transitory machine-readable storage medium of claim 1, wherein the sensing of the physical world includes instructions to execute a pose detection of the augmented reality display (53) relative to the physical world.

12. The non-transitory machine-readable storage medium of claim 1, wherein the sensing of the physical world includes instructions to execute an ambient detection of an operating environment of the augmented reality display (53) relative to the physical world.

13. The non-transitory machine-readable storage medium of claim 1, wherein the instructions to autonomously control the positioning of the virtual object within the augmented reality display (53) based on the decisive aggregation further includes instructions to execute an operational assessment of at least one technical specification of the augmented reality display (53).

14. The non-transitory machine-readable storage medium of claim 1, wherein the virtual object positioning controller (60) is further configured to autonomously control the positioning of the virtual object within the augmented reality display (53) based on the decisive aggregation further includes instructions to execute a virtual assessment of a positioning of one or each of at least one additional virtual object within the augmented reality display (53).

15. The non-transitory machine-readable storage medium of claim 9, wherein the instructions to autonomously control the positioning of the virtual object within the augmented reality display (53) further includes instructions to:
spatially map the physical world from at least one of a view of the physical object within the physical world and a sensing of at least one marker within the physical world.

16. An augmented reality method, comprising:
displaying, via an augmented reality display (53), a virtual object relative to a view of a physical object within a physical world; and
autonomously controlling, via a virtual object positioning controller (60), a positioning of the virtual object within the augmented reality display (53) based on a decisive aggregation of:
an implementation of at least one spatial positioning rule regulating the positioning of the virtual object within the augmented reality display (53); and
a sensing of the physical world.

17. The augmented reality method of claim 16, wherein the sensing of the physical world includes at least one of:
executing, by the virtual object positioning controller (60), an object detection of the at least one physical object within the physical world;
executing, by the virtual object positioning controller (60), a pose detection of the augmented reality display (53) relative to the physical world. executing, by the virtual object positioning controller (60), an ambient detection of an operating environment of the augmented reality display (53) relative to the physical world.

18. The augmented reality method of claim 16, wherein the autonomously controlling, via the virtual object positioning controller (60), of the positioning of the virtual object within the augmented reality display (53) based on the decisive aggregation further includes at least one of:
an operational assessment of at least one technical specification of the augmented reality display (53); and
a virtual assessment of a positioning of one or each of at least one additional virtual object within the augmented reality display (53).

19. The augmented reality method of claim 16, wherein the autonomously controlling, via the virtual object positioning controller (60), of the positioning of the virtual object within the augmented reality display (53) includes: spatially mapping the physical world from at least one of the view of the physical object within the physical world and a sensing of at least one marker within the physical world.

20. The augmented reality method of claim 19, wherein the marked-based spatial mapping includes at least one of a single marker tracking, a nested marker tracking, a multi-marker tracking and a multi-modality tracking.
